(19) United States
(12) Patent Application Publication
(10) Pub. No.: US 2004/0026921 A1
(43) Pub. Date: Feb. 12, 2004

(54) Label for concealing information

(75) Inventors: Malte Krone, Hamburg (DE); Arne Koops, Breitenfelde (DE); Sven Reiter, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: tesa Aktiengesellschaft, Hamburg (DE)

(21) Appl. No.: 10/340,455

(22) Filed: Jan. 10, 2003

(30) Foreign Application Priority Data
Mar. 14, 2002 (DE) 102 11 744.6
Apr. 17, 2002 (DE) 102 17 120.3

(51) Int. Cl. B42D 15/00

(52) U.S. Cl. 283/92

(57) ABSTRACT

A label for concealing information, comprising at least

a) a transparent backing layer, in particular of plastic,

b) containing an additive which shows a change of color under laser irradiation,

c) on whose surface a logo has been produced which is composed of an ink comprising a luminescent, (fluorescent or phosphorescent) color pigment, and which

d) has been coated on one side, on the surface opposite the surface bearing the logo, with a self-adhesive composition which

e) where appropriate has been lined with a release paper or release film.

The invention relates to a label for concealing information, comprising a backing layer, in particular a varnish layer, composed especially of thermosetting varnish for laser marking, with an adhesive layer on the bottom face of the backing layer, and to the use thereof.

For characterizing parts on vehicles, machines, electrical and electronic instruments, and packaging, especially one-way containers, the use of technical labels is on the increase: for instance, as model identification plates, as control labels for operating sequences, and as badges of guarantee and testing.

The labels serve typically to offer information, this information being produced by printing or by laser marking on the label.

Recently, the spotlight has enlarged to cover fields of use in which the purpose of the label is not to transmit information but instead, in contrast, to conceal information, either right from the start of bonding or later, so that the information is initially accessible and disappears or is covered over only following manipulation of the label.

One example of a latter field of use is in the takeback of one-way containers for which a deposit is to be paid out on return. For this purpose it is conceivable to provide on the container an area which is covered over by a label. After the container has been thrown into an apparatus intended for this, the container could be devalorized in the apparatus by an irreversible manipulation of the label within said apparatus.

Any attempt to return the container labeled with the altered label again, with the aim of improperly obtaining a further monetary deposit, would be immediately evident from the “devalorization” of the label.

Furthermore, this application contains the need for a more or less pronounced extent of anticounterfeit security. This anitcounterfeit security applies primarily to the period of application and the entire usage life on the part which is to be labeled. Removal or manipulation should be possible only with destruction or visible, irreversible alteration. In order to increase further the anticounterfeit security of the labels, a demand increasingly being imposed on the labels themselves is that they contribute to the security by means of a particular design.

In particularly sensitive fields of use there must be a security stage for the production of the labels as well. If it were too easy to acquire and mark such labels, and if imitations were produced, unauthorized persons would be provided with the possibility of improperly trafficking in the articles concerned.

This additional anticounterfeit security must not, however, stand in the way of subsequent identification of the adhered label for originality, by a rapid, unambiguous, simple, and nondestructive method.

One-way beverage containers will in future likewise be subject to the deposit system. In other words, the customer buys the container and its contents and puts down a certain monetary deposit. On return of the container (predominantly plastic bottles) the customer is paid the corresponding deposit.

To simplify return, it may take place in appropriately designed machines. The customer throws in the container and the machine recognizes this container and pays out the deposit.

It is very important here that the machine devalorizes the container, so that it cannot be returned a second time.

By way of example, consideration has been given to initially identifying the container from the bar code and releasing the money by means of this information. The bar code or the information it conveys should then be destroyed, so that a second encashment of the deposit, by the bar code being read a further time, is impossible.

DE U 81 30 861 discloses a multilayer label comprising a thin varnish layer and a thick, self-supporting, hidingly pigmented varnish layer. Both layers are composed of a solventlessly applied, electron beam cured varnish, the thicknesses of the layers being different. The label is marked by using a laser to burn away the upper, thinner varnish layer, so that the lower, thicker varnish layer becomes visible, the lower layer preferably contrasting in color with the first layer.

Such marking constitutes' a type of gravure, that removes the possibilities for manipulation associated with traditional printing with inks. As a result of the raw materials employed and the production operation, the label is rendered so brittle that it is virtually impossible to remove it from the bond substrates without it being destroyed.

In terms of anticounterfeit security, the very brittle construction of a laser film product such as that known from DE U 81 30 861 and available, for example, as tesa 6930® from tesa, offers a good basis for documenting and hence foiling any attempts at manipulation.

Removing the laser-marked label in one piece, without destruction, from its original bond substrate can be done only at very great expense and subject to certain preconditions.

EP 0 645 747 A specifies a laser-markable multilayer label material which is composed of a first layer, and of a second layer which differs optically from the first, said first layer being removable by means of laser radiation in accordance with a desired textual or print image, making the surface of the second layer visible. Arranged between the layers, furthermore, is a transparent plastic film which forms a backing layer.

DE 44 21 865 A1 specifies a monolayer laser label comprising a backing layer of plastic which contains an additive that changes color under laser irradiation.

The backing layer is coated on one side with a self-adhesive composition which is lined, where appropriate, with a release paper or release film.

DE 199 09 723 A1 disclosed a security film having a backing layer in which there is an identification medium. By means of a contactless inscription operation it is possible selectively and locally to alter the diffusion properties of this identification medium in a specific way. When the security film thus inscribed is adhered to a workpiece, the identification medium diffuses toward the surface of the substrate, where it brings about a detectable reaction. This diffusion or reaction takes place only in those regions of the substrate surface in which the operation of inscription has initiated, or has not hindered, the defusibility. Accordingly, the security film allows unambiguous inscription and identification of the workpiece.

The security film is inscribed by means of a contactless process. Thus it is possible to achieve an inscription which is rapid, can be varied flexibly and is insensitive to dirt even in a plant environment. The inscribing of the security film—and hence the changing of the diffusion properties of the identification medium—may take place in particular with the aid of electromagnetic radiation. To inscribe the security film it is particularly advantageous to use a laser which allows both temperature-sensitive and light-sensitive inscription (as used here, “light” embraces the entire range of the electromagnetic spectrum that is available to the laser). Lasers have the further advantage of enabling high-contrast inscriptions with a free choice of pattern, of allowing rapid changes to the pattern inscribed, and of operational reliability in use in the plant environment.

Using flat, sharp blades, moreover, it is possible to separate labels completely from the substrate. Particularly on plastic substrates such as polyethylene or polypropylene, the bond between adhesive and substrate shows weaknesses.

Despite increased bond strength on metallic or painted substrates, it is possible there as well to detach part of the labels without destroying them, by using special tools. A special bladed tool can be guided at a shallow angle beneath the label. By means of careful cutting movements it is possible to lift one edge, so producing what is termed a grip tab. In this way a point of attack is produced which makes detachment easier.

An additional security aspect is disclosed in DE 199 04 823 A1. Here, a process for producing a film is described in which first of all a support sheet is embossed by means of an embossing tool which has holographic structures. Subsequently, a film is produced on the embossed support sheet, such that at least one hologram appears on the film.

Powerful, controllable lasers for burning markings such as text, codes and the like are widespread. The material to be marked is subject to requirements including the following:

It should be rapidly markable.

A high spatial resolution should be achieved.

It should be extremely simple to use.

The decomposition products should not be corrosive.

For special cases, the following additional features are called for:

High temperature stability, up to more than 200° C. for example.

Good stability to weathering, water, and solvents is desired.

Known materials used for this purpose, such as printed paper, eloxed aluminum, painted metal sheet or PVC films, do not meet all of these requirements.

It is an object of the invention to provide a possibility for specifically concealing information by means of a label so that, for example, after the label has been marked with a laser the hitherto (machine-)readable content beneath the label can no longer be evaluated. Detachment of the label should not be possible without entailing its destruction. Moreover, the invention ought to respond to the call for improved anticounterfeit security.

This object is achieved by a label as described in the main claim. The subclaims relate to particularly advantageous embodiments of the subject matter of the invention and to possible uses for the label of the invention.

The invention accordingly provides a label for concealing information, comprising at least

a) a transparent backing layer, in particular of plastic,

b) containing an additive which shows a change of color under laser irradiation,

c) on whose surface a logo has been produced which is composed of an ink comprising a luminescent (fluorescent or phosphorescent) color pigment, and which

d) has been coated on one side, on the surface opposite the surface bearing the logo, with a self-adhesive composition which

e) where appropriate has been lined with a release paper or release film.

The logo can be applied to the backing layer by printing or embossing, for example.

The backing layer preferably has a thickness of 10 to 200 μm, in particular from 50 to 100 μm.

Suitable backing layers are composed of plastics such as polyesters, poly-(meth)acrylates, polycarbonates and polyolefins, and of radiation-curable systems such as unsaturated polyesters, epoxy acrylates, polyester acylates and urethane acrylates, such as are also employed for UV printing inks, particularly those comprising base polymers in accordance with DE U 81 30 861, namely aliphatic urethane acrylate oligomers.

The additive may be a pigment, especially copper hydroxide phosphate or Iriodin, a pearl luster pigment, based on basic lead carbonate, or mica, and titanium dioxide can be used as well as the additive.

Furthermore, the additive may be a thermochromic dye.

Suitable additives are, in particular, metal salts, especially copper hydroxide phosphate or else Iriodin, a pearl luster pigment available commercially from Merck. These additives are admixed to the base polymers (such as, for example, those described in DE U 81 30 861) in particular in the order of magnitude ranging from a few parts per thousand up to a maximum of 10% by weight, preferably in amounts from 0.1 to 10% by weight, in particular from 0.5 to 5% by weight, based on the overall weight of the backing layer. Following production of sheet material by known methods such as extrusion, casting, coating, etc., with subsequent radiation-chemical crosslinking where appropriate, such films are coated with the adhesive layer.

Lining with siliconized release paper then produces the typical construction for stock material from which labels can be manufactured.

When standard lasers are utilized, particularly the widespread Nd-YAG solid-state lasers having a wavelength of 1.06 μm, a color shift or color change takes place at the point where the laser is incident on the surface of the material, and rapid, full-area inscriptions or color changes are obtained.

in a further advantageous embodiment, the backing layer is composed of a varnish, in particular of a cured varnish, preferably a radiation-cured varnish, with particular preference an electron beam cured polyurethane acrylate varnish. Advantageously, the varnish is a brittle varnish. The brittleness of the varnish is one reason why, after bonding, the lack of flexibility in the backing means that the label cannot be removed but instead fragments during any attempt to detach it.

In one alternative embodiment the backing layer is composed of a polybutylene terephthalate.

In principle, four types of varnish can be used, provided their stability is sufficient, for example, acid-curing alkyd-melamine resins, addition-crosslinking polyurethanes, free-radically curing styrene varnishes, and the like. Particularly advantageous varnishes, however, are radiation-curing varnishes, since they cure very rapidly without laborious evaporation of solvents or exposure to heat. Varnishes of this kind have been described, for example, by A. Vrancken (Farbe und Lack 83,3 (1977) 171).

It has been found particularly advantageous for the varnish layer to contain a further additive at not less than 5% by weight, preferably 7% by weight, which is fluorescent or phosphorescent or which is suitable for magnetic or electrical characterization.

An alternative to using luminescent substances is to incorporate into the varnish layer substances which can be detected magnetically or electrically, and also thermochromic pigments which react to temperature change by undergoing reversible color change. Changes in magnetic fields, such as in the case of alarmed labels for articles of clothing, for example, are possible in principle but are not predestined for the fields of use preferred in accordance with the invention.

One appropriate hidden security stage is to add to the varnish layer, for example, substances which render the layer electrically conductive. By means of appropriate measuring instruments, which are portable, easy to operate, and inexpensive to purchase, and suitable electrodes, the conductivity of the varnish layer can be determined directly on the bonded label. The electrodes are attached at two different points A and B of the varnish layer and a voltage is applied. In the presence of unbroken electrical conductivity between A and B, a current flow can be measured which can have a characteristic value depending on the nature and amount of the additive used. Since even when the label is used directly on metals the varnish layer is separated from the conductive metal by the electrically insulating adhesive layer, there is no risk of erroneous measurements.

Counterfeiting by subsequent manipulation is ruled out in particular by virtue of the fact that the conductivity measurement can be made not only from edge to edge of the labels but also between arbitrary points.

For conductivity to be detectable in this case, the entire varnish layer must be of unbroken 3-dimensional conductivity, something which can be ensured only as part of the original production process. A laser-markable label of this kind can be produced by adding electrically conductive substances to the formulation of the varnish layer; this can be done either in addition to the existing pigments or else as an at least partial replacement of the existing pigments, in order to retain the good processing properties of the varnish pastes. Suitable conductive additives are, in principle, electrically conductive metallic, organic, polymeric, and inorganic substances, preference being given to the use of metals. Especially for transparent varnish layers, the intrinsic color of the conductive additive must be borne in mind when making the selection. Conductive carbon black is likewise suitable, but gives a marked black coloration to the backing layer.

In order to ensure good conductivity there should be a minimum limit concentration of additive, so that sufficient particles are present in the varnish layer to have contact with one another. Below this limit concentration, a conductive pathway from A to B is no longer ensured in the 3-dimensional microstructure of the base layer. Preference is therefore given to using metallic particles, with fibers of high length to cross-sectional ratio being preferred because, using such fibers, it is possible to ensure 3-dimensional conductivity with lower concentrations than with spherical particles; in addition, the effect on the color of the varnish layer is smaller with the fibers. On the basis of cost/benefit analysis, metals employed are preferably copper, iron, aluminum and steel and also their alloys, although expensive metals of high conductivity, such as silver and gold, are also suitable. The fiber dimensions are 0.1 to 50 mm in length and from 1 to 100 μm cross sections, preference being given to the use of metal fibers having a diameter of from 2 to 20 μm with a cross section to length ratio of from 1:100 to 1:1000. Fibers of this kind are incorporated homogeneously into the known formulation at from 0.5 to 25% by weight, preferably from 2 to 10% by weight, and are coated and cured in accordance with DE U 81 30 861.

The additives which can be added to the backing layer may be fine colored pigments or else, preferably, visible particles with a size in the order of 0.1 to 5 mm. Using finely ground color pigments produces a slight shift in the shade of the indicia, while the visible particles produce a characteristic mosaic. When daylight-fluorescent inks are employed, the “fingerprint” is perceptible without auxiliary means, something which is frequently unwanted. It is therefore preferred to use color pigments or particles which do not absorb in the region of visible light and hence in the normal case are invisible—only when the label is eliminated with a lamp of appropriate wavelength are the color pigments excited to produce their characteristic luminescence.

In addition to color pigments excited by IR radiation, it is predominantly UV-active systems which are employed. Also suitable in principle are luminescent substances which are excited by electron beams, x-rays, and the like, and also thermochromic pigments which change color reversibly when the temperature changes.

When selecting the color pigments it should be ensured that they are of adequate stability for the production of the labels (film production, adhesive coating) and do not undergo irreversible changes under the processing conditions (possibly thermal drying, electron beam or UV curing and the like). For long-term applications of the labels it is advantageous that these luminescent substances, which are sensitive in the majority of cases, are embedded in a polymer matrix. Further measures to counter mechanical abrasion and to protect against direct contact with oxygen and water are unnecessary.

For said additives it is possible to use the same long-afterglow (phosphorescent) or fluorescent color pigments as used for the color pigments present within the ink.

These color pigments are excited only or predominantly by UV radiation and emit in the visible range of the spectrum (as an overview see, for example, Ullmann's Enzyklopädie der technischen Chemie, 4th Edition, 1979, Verlag Chemie).

Also known, however, are IR-active luminescent pigments. Examples of systems with UV fluorescence are xanthenes, coumarins, naphthalimides, etc., which in some cases are referred to in the literature under the generic term “organic luminophores” or “optical brighteners”. The addition of a few percent of the luminescent substances concerned is sufficient.

Examples of formulations which can be employed are those with RADGLO® pigments from Radiant Color N.V., Netherlands or Lumilux® CD pigments from Riedel-de Haen Inorganic luminescent substances are also suitable. As long-after glow substances, particularly with emission of light in the yellow region, metal sulfides and metal oxides have proven favorable, generally in conjunction with appropriate activators. They are obtainable, for example, under the trade name Lumilux® N or, as luminescent pigments improved in terms of stability, luminosity and after-glow persistence, under the trade name LumiNova®) from Nemoto, Japan.

These dyes/pigments exemplified are incorporated into the formulation of the varnish layer or of the ink, respectively, in amounts of 0.1 to 50% by weight, preferably at from 1 to 25% by weight, with very particular preference at 7% by weight. Final coatings of the varnish layer with adhesive and, where appropriate, lining with release paper or release film produces the label stock material for customer-specific use.

After punching/laser cutting of the desired label geometries, and following final marking by means of laser beam with indicia, bar codes, logos, etc., the label is present in its final form. When long-afterglow color pigments, for example, are incorporated into the ink layer, the label—following appropriate excitation of the luminescent pigments—exhibits a characteristic phosphorescence, allowing it to be identified rapidly and easily as an original label. Apart from the special light source and, if appropriate, a viewing shield to eliminate disruptive ambient light, no further complex equipment is needed—following examination, the label remains unaltered.

Labels of this kind which comprise, in the ink of the logo, luminescent substances which emit in the visible wave length range only following UV or IR excitation are also suitable for register-accurate manufacturing (printing, punching, application, etc). Instead of separately applied printing or control marks, it is possible in the course of processing to utilize the light emission of the logo for this purpose: in particular, following the marking and slitting of the labels by means of a laser beam from unpunched roll material, a downstream control unit is able, with suitable equipment, to use the excitation and emission at a defined area of the label as a control mark for further processing steps and/or for the production of the next label.

Customer-specific “fingerprinting” of the labels can be brought about by printed application of different logos. Regular patterns of lines and strokes in particular allow characteristic patterns of points of luminescence to be produced and, moreover, are particularly sparing in terms of material and costs. Following the punching or laser slitting of the label and application to the bond substrates, a pattern which is characteristic in terms of colors and geometries can be perceived at the edge of the label when an appropriate source of illumination is chosen.

The advantage of this security marking is manifested in particular in terms of logistics and costs. Commercial printing inks and nonspecific label film material can be employed and yet said material can otherwise be produced in a customer-specific manner. Since such standard stock material is used by label manufacturers only as an intermediate even for their own manufacture and is not freely available on the market, however, there is no possibility of unauthorized access. In addition, small batch sizes and short delivery times are possible.

Preference is further given to an embodiment of the label which is composed of a varnish layer obtainable by applying the varnish layer, preferably solventlessly, to a printed or embossed support sheet and then curing it. Furthermore, a hologram may have been applied to the varnish layer.

It has proven advantageous if the varnish layer is self-supporting and hidingly pigmented and if the varnish layer is electron beam cured.

It has further proven advantageous if the support sheet is a polymer film, particularly a polyester film.

The support sheet is printed in particular by flexographic printing, since UV flexographic printing allows a very high degree of freedom in terms of the design of geometries and, particularly for materials in web form, from paper to film, provides a good print quality for a very low price. With this technology it is possible to transfer lines, areas, images, logos, indicia, etc. in different sizes and varieties from the printing plate to the print substrate.

The principal influencing factors for this process are:

Pre-press stage (reprographic elaboration of the printing plate)

Printing forme

Construction of print format

Material on which printing is to take place

Screen roller

Printing ink

Ink application

Print tension

In the above-described application of the counterfeitproof, laser-markable labels, the requirement is preferably for logos and text of varying complexity; it is in this context that the UV flexographic printing process can be used to good effect.

For this purpose, a printing plate bearing the logos and text is wetted with printing ink, which is transferred to a polymeric sheet. The printing ink can then be cured on the sheet by physical activation (thermally, radiation-chemically). For this purpose the ink ought to become strongly adhered to the sheet substrate; this is vital for further processing. Print anchoring is to be tested prior to further processing. This is done using the cross-cut test (DIN EN ISO 2409). In the cross-cut test the print ought to obtain an evaluation of at least Gt 02.

In order to achieve a high level of adhesion/print anchoring, it is necessary for the printing ink to be selected or formulated appropriately as a function of the sheet material and/or to use a pretreatment technique for the printing sheet. In this case it is possible, preferably, to choose corona treatment, which can be employed in line with the printing. When a PET sheet is used, the surface tension ought to be set at >50 mN/m. This can be measured using standard test inks.

Depending on the UV emitter, UV curing ought to possess a percentage power setting of between 50% and 100%, in order to ensure sufficient flexibility of the print for downstream processing operations.

In order to achieve an impression result which is subsequently visible and sensorially perceptible on the laser label, the print ought to possess a height of between 0.1 μm and 15 μm. A height of 5 μm is preferably chosen. The visual impression and character of the print may also be varied by the pattern of the printed dots.

To realize the invention it is also possible to employ the other conventional printing processes, which are known as relief printing processes. These include letterpress and screen printing.

The support sheet can be printed with a wide variety of designs: company logos or advertising, for example. The printing of the support sheet produces a negative impression on the visible surface of the first varnish layer of the label of the invention.

It is particularly preferred if in the first varnish layer the impression of the printed support sheet is present as an indentation of from 0.1 to 15 μm, preferably from 1 to 5 μm.

The label of the invention may also be produced on an embossed support sheet; for example, likewise on a polyester sheet of preferably from 25 to 100 μm in thickness, in particular 50 μm.

The support sheet can be printed with a wide variety of designs: company logos or advertising, for example. The embossing of the support sheet produces a negative impression on the visible surface of the first varnish layer of the label of the invention.

The embossing of the support sheet can be carried out, for example, in varying thickness and/or depth using a metal embossing die (available from Gerhardt). The depth of embossing is dependant on the embossing pressure set, which acts on the magnetic cylinder used in the embossing process, and on the nature of the counterpressure cylinder. Ensheathing the counterpressure cylinder (with tesaprint® or with a polyester film, for example) results in strong embossing.

It is also possible for the embossing tool used to have holographic structures, so that the structure is transferred to the varnish layer and results in at least one hologram.

Consequently, the side of the embossing tool facing the material to be embossed is shaped so as to give a structure which comprises a diffraction grating or a holographic image.

Since the hologram is produced within the varnish layer itself, there is no harmful multilayer structure, and the diffraction grating produced in this way possesses the same resistance and laserability as the varnish layer itself.

In one advantageous embodiment the support sheet is composed of a permanently embossed thermoset or thermoplastic material, in particular of polyester or polyamide.

In the process producing such a label, the varnish layer is applied to the support sheet and is cured under effectively oxygen-free conditions by exposure to an electron beam of high energy (from 150 to 500 kV).

This is followed by coating with the adhesive and subsequently, if desired, by lining with the protective paper. Thereafter the polyester sheet is removed so that the free surface of the first, upper layer is visible. Depending on the design of the surface of the polyester sheet it is glossy, smooth, matt or embossed.

The pressure sensitive adhesive is, for example, an adhesive as disclosed in DE 15 69 898 C. The content of the entire disclosure of said document is therefore part of this invention.

By way of example, an acrylate adhesive is applied at 25 to 35 g/m².

The adhesive layer designed in accordance with the invention does not adversely affect the label. There is no change in physical and chemical resistance.

From the application standpoint the label does not suffer any detriment as far as laser markability or legibility of information is concerned.

With particular advantage the label can be used for concealing information, especially such that when the label is adhered above information present on an article and is lasered to conceal the information the resultant color change in the label means that the information can no longer be evaluated.

It should be emphasized that the security feature of the label in the form of the logo, where appropriate also in the form of images or of text, is retained after lasering, albeit not necessarily legibly without auxiliary means.

Use on packaging, preferably one-way beverage containers, is particularly advisable, there being a bar code beneath the label.

The one-way beverage containers may be drinks cans (cola, beer, etc.), for example, one-way glass bottles with paper label, one-way plastic bottles with paper label, beverage containers with a plastic label, or directly printed glass or plastic bottles.

The label of the invention features a multiplicity of advantages which were not foreseeable in such a way for the skilled worker.

Following application the labels are virtually imperceptible; they are substantially invisible optically and cannot be sensed by touch.

Identification is possible without auxiliary means; in other words, authenticity testing can be performed without UV or IR lamps, etc., depending on embodiment.

Since the identification is unambiguous, the risk of an incorrect assessment is small.

Without the use of appropriate auxiliary means, detaching the labels, especially laser labels, without destruction is impossible owing to the high level of brittleness.

The label can be adhered automatically to the bar code area, with the bar code remaining legible at the point of sale and at the point of return.

The label does not detach from the product during the product cycle.

Following treatment in the machine the label is altered so that text present beneath the area of the label which was marked is no longer legible. The alteration to the label is irreversible. Nevertheless, following irreversible alteration, the label can be identified as an original label.

The drawing shows in

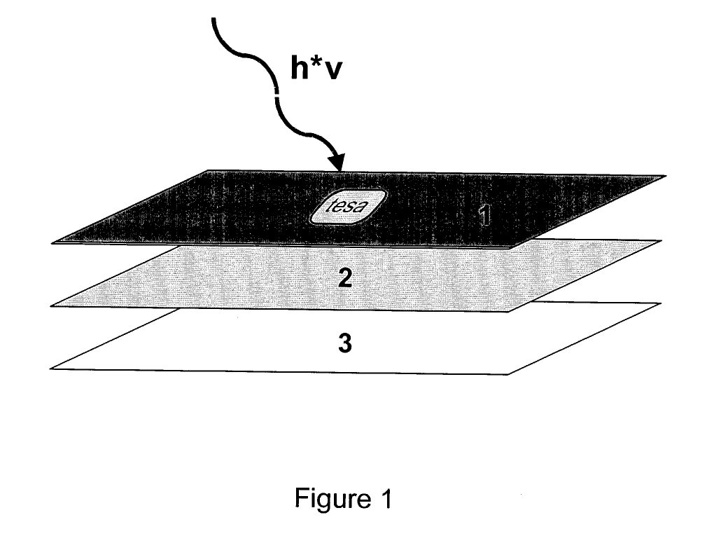

FIG. 1 the structure of the label of the invention,

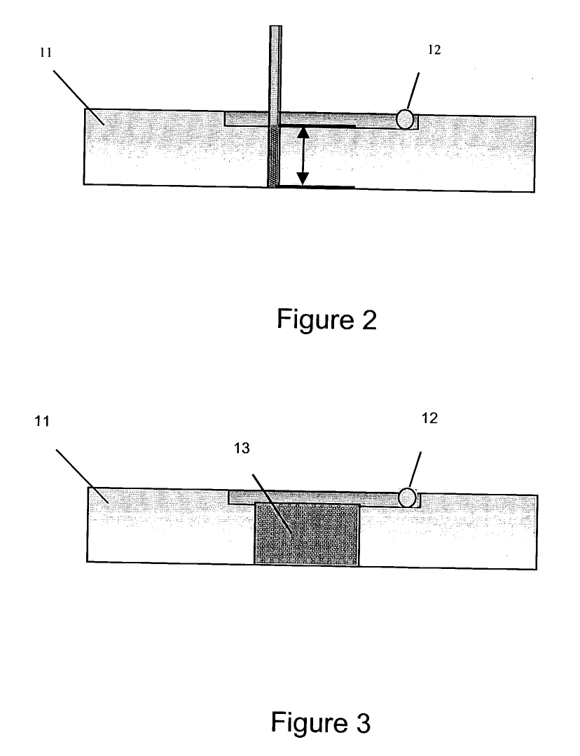

FIG. 2 the process of marking the label of the invention,

FIG. 3 the label of the invention after marking.

In the structure of the label of the invention, shown in FIG. 1, a first PU acrylate layer is present on a layer of an adhesive 2, in particular a pressure sensitive adhesive, which is lined with a release paper 3.

In the course of marking with a laser, an individual photon strikes a pigment whose color changes; the formerly transparent layer 1 becomes black.

Produced in the label 11 is a layer 12 in the form of a logo which contains an additive that responds to UV radiation. The label 11 can be marked without damaging or deactivating the cast-in UV feature.

The layer 12 is translucent (transmissive) for the Nd-YAG laser beam at 1.06 μm, so that below the UV logo the label 11 is subject to the normal process of color change. Accordingly, the UV logo can also be detected in full after marking, as is evident from FIG. 3. The region 13 represents the marked region, which completely conceals the substrate as a result of the color change which has taken place.

### EXAMPLE

In the example below a particularly advantageous label is disclosed which is produced using a printed support sheet, so that on the surface of the label there arise embossments (positive or negative) which result in a further high security factor.

The support sheet to be printed, in this case a polyester film (Hostaphan RN 75®) from Mitsubishi, is treated for the desired surface tension, prior to printing, by means of corona treatment in an appropriate manner. This can be done using a VETAPHON Corona Plus DK—E-treater ET 2 corona station with a power from 0.2 to 2.0 kW. For further processing it is advantageous to set the surface tension at >50 mN/m.

A cationically curable UV varnish SICPA 360076 from SICPA, Aarberg, is employed, which is tinted blue. The printing ink is optimized for processing through the admixture of 5% by weight of cylinder repellent.

By means of an ARSOMA em 410 or em 510 UV flexographic printing machine, the pretreated polyester film is printed via a flexographic printing station at a machine speed of 30 m/min. The precisely defined transfer of ink to the flexographic printing plate is accomplished by means of a corresponding screen roller by the negative doctor blade technique. Accordingly, the transfer of ink from plate to sheet substrate takes place with an ink level of 3 to 4 μm

The ink applied to the sheet substrate is cured by means of powerful UV tube emitters. For this purpose use is made of a micro UV station GEW UV station with a lamp output of 100 w/cm and a wavelength of 365 nm. The support sheet has now been made ready for further processing.

A commercial transparent polyurethane acrylate made from long-chain polyesterdiol and aliphatic diisocyanate, and having terminal acrylic groups (molecular weight about 1500, functionality 2) is mixed with 20% of hexanediol bisacrylate. This gives a highly viscous liquid of approximately 10 Pa*s.

This liquid is coated in a thickness of 10 μm onto a 50 μm, biaxially oriented, and embossed polyester film and is cured under an inert gas by an electron beam of 350 keV with a dose of 1 Mrad.

Atop this product there is coated a pressure sensitive adhesive according to DE 15 69 898 A1, so that the layer after drying has a thickness of 20 μm. The pressure sensitive adhesive is lined with commercial release paper.

The polyester sheet is then removed, so that the surface of the product, which has been provided with embossments but is otherwise mirror-smooth, is visible.

This surface can be quickly marked with a controllable power laser, so that the label changes from transparent to black/grey.

The mixture chosen to produce the logo is composed of a varnish from SICPA, namely Sicura Flex 3600076, to which 5% by weight of lumipaste 806205, likewise from SICPA, is admixed.

1. A label for concealing information, comprising at least
a) a transparent backing layer, in particular of plastic,
b) containing an additive which shows a change of color under laser irradiation,
c) on whose surface a logo has been produced which is composed of an ink comprising a luminescent, (fluorescent or phosphorescent) color pigment, and which
d) has been coated on one side, on the surface opposite the surface bearing the logo, with a self-adhesive composition which
e) where appropriate has been lined with a release paper or release film.

2. The label as claimed in claim 1, wherein the backing layer is composed of a varnish, in particular of a cured varnish, preferably a radiation-cured varnish, especially a brittle varnish

3. The label as claimed in claim 1, wherein the backing layer is composed of an electron beam cured polyurethane acrylate varnish.

4. The label as claimed in claim 1, wherein the additive is a pigment, especially copper hydroxide phosphate, a pearl luster pigment based on basic lead carbonate, or a mica with titanium dioxide and/or a thermochromic dye.

5. The label as claimed in claim 1, wherein the additive is used in amounts of 0.1 to 10% by weight, based on the overall weight of the backing layer.

6. The label as claimed in claim 1, wherein as well as the additive titanium dioxide is used as pigment.

7. The label as claimed claim 1, wherein the backing layer has a thickness of from 10 to 200 μm.

8. Method of using the label as claimed in claim 1 for concealing information, comprising applying the label to an article.

9. Method of using the label as claimed in claim 1, the label being bonded above information which is present on an article and being lasered to conceal the information, so that as a consequence of the resultant color change of the label it is no longer possible to evaluate the information.

10. Method of using the label as claimed in at claim 1 on packaging, comprising applying the label to packaging, on packaging, there being a bar code beneath the label.

11. The label as claimed in claim 1, wherein the additive is used in amounts of 0.5 to 5% by weight, based on the overall weight of the backing layer.

12. The label as claimed claim 1, wherein the backing layer has a thickness of from 10 to 200 μm.
